(19) United States
(12) Patent Application Publication
(10) Pub. No.: US 2025/0153359 A1
(43) Pub. Date: May 15, 2025

(54) ROBOT CONTROL DEVICE AND ROBOT SYSTEM

(71) Applicant: FANUC CORPORATION, Yamanashi (JP)

(72) Inventors: Nao OOSHIMA, Yamanashi (JP); Gou INABA, Yamanashi (JP)

(73) Assignee: FANUC CORPORATION, Yamanashi (JP)

(21) Appl. No.: 18/839,211

(22) PCT Filed: Feb. 25, 2022
(86) PCT No.: PCT/JP2022/007880

§ 371 Date: Aug. 16, 2024

(51) Int. Cl. B25J 9/16; B25J 19/06

(52) U.S. Cl. CPC B25J 9/1674; B25J 19/06

(57) ABSTRACT

A robot control device according to one embodiment of the present disclosure comprises: a communication processing unit for acquiring, from an enable device, an operation state indicating whether operation of a robot is to be permitted; an alarm setting unit for stopping movement of the robot and setting an alarm when an operation state indicating that operation of the robot is not permitted is acquired, or another abnormality of the robot that is not based on the operation state is detected; and an alarm cancelation unit for executing a cancelation process for canceling the relevant alarm only when an operation state indicating that operation of the robot is permitted is acquired in a state in which the alarm has been set and also the alarm that has been set is the alarm based on the aforementioned operation state.

### TECHNICAL FIELD

The present disclosure relates to a robot control device and a robot system.

### BACKGROUND ART

According to a conventionally known technique, in order to ensure safety, a robot action is permitted to be made on the basis of an operation state of an operation performed on an enable apparatus by an operator, and the robot is stopped when the operation state of the enable apparatus has switched to a state in which operation of the robot is not permitted. Patent Documents 1 and 2 pertain to this type of technique.

### CITATION LIST

### Patent Document

Patent Document 1: Japanese Unexamined Patent Application, Publication No. 2015-020215

### Patent Document 2: Japanese Unexamined Patent Application, Publication No. 2007-326163

### DISCLOSURE OF THE INVENTION

### Problems to be Solved by the Invention

With that having been said, if an abnormality occurs in the robot, the robot is stopped, and an alarm for informing the abnormality is set. An alarm is also set when the operation state of the enable apparatus has been switched to a state in which operation of the robot is not permitted. However, setting an alarm every time the enable apparatus is re-gripped makes it difficult to identify an alarm that indicates another abnormality and thus is different from the alarm based on the operation state of the enable apparatus. Accordingly, enhancing the efficiency of the alarm identifying task has been desired.

An object of the present disclosure is to provide a robot control device and a robot system that are capable of enhancing the efficiency of the task of identifying an alarm indicating an abnormality of a robot.

### Means for Solving the Problems

A robot control device according to one aspect of the present disclosure includes: a communication processing unit that obtains, from an enable apparatus, an operation state indicating whether or not operation of a robot is permitted; an alarm setting unit that stops an action of the robot and sets an alarm in a case where the operation state indicating that operation of the robot is not permitted has been obtained or another abnormality of the robot that is not based on the operation state has been detected; and an alarm cancellation unit that, in a case where the operation state indicating that operation of the robot is permitted has been obtained with the alarm having been set, performs, when an only alarm that has been set is the alarm based on the operation state, cancellation processing for cancelling the alarm that has been set.

### Effects of the Invention

The present disclosure allows a robot control device and a robot system to be provided, the robot control device and the robot system being capable of enhancing the efficiency of the task of identifying an alarm indicating an abnormality of a robot.

### BRIEF DESCRIPTION OF THE DRAWINGS

FIG. 1 is a schematic diagram illustrating the configuration of a robot system according to a first embodiment of the present disclosure;

FIG. 2 is a schematic diagram of a robot operation device, the schematic diagram illustrating enable switches provided for a robot control device according to the first embodiment;

FIG. 3 is a block diagram illustrating a configuration example of the robot control device according to the first embodiment;

FIG. 4 is a flowchart illustrating an example of alarm processing based on an operation state achieved by the robot control device according to the first embodiment;

FIG. 5 is a schematic diagram illustrating the configuration of a robot system according to a second embodiment of the present disclosure;

FIG. 6 is a schematic diagram illustrating the configuration of a robot system according to a third embodiment of the present disclosure; and

FIG. 7 is a schematic diagram illustrating the configuration of a robot system according to a fourth embodiment of the present disclosure.

### PREFERRED MODE FOR CARRYING OUT THE INVENTION

With reference to the drawings, the following describes embodiments of a robot system to which a robot control device according to the present disclosure is applied.

### First Embodiment

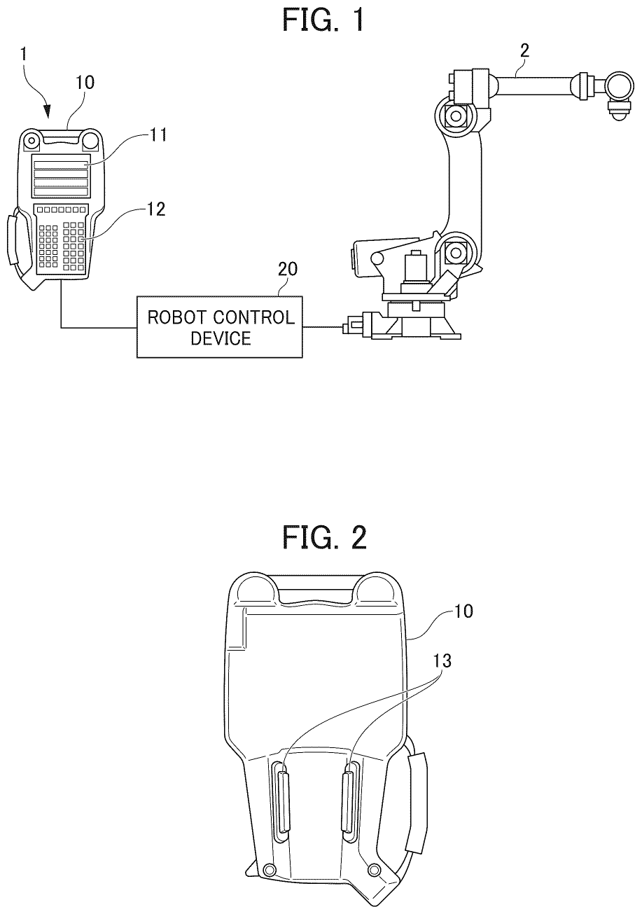

FIG. 1 illustrates the configuration of a robot system 1 according to a first embodiment of the present disclosure. The robot system 1 in FIG. 1 includes a robot 2, a robot operation device 10, and a robot control device 20.

For example, the robot 2 may be an articulated robot such as a six-axis vertical articulated robot or a four-axis vertical articulated robot. The robot 2 is disposed inside a safety fence and electrically connected to the robot control device 20. The robot 2 is not limited to an articulated robot, and may be, for example, a Cartesian coordinate robot, a SCARA robot, or a parallel link robot.

For example, the robot operation device 10 is a teaching operation panel with which task details and/or task positions are set for the robot 2. The robot operation device 10 is electrically connected to the robot control device 20. The robot operation device 10 includes a display unit 11, an input operation unit 12, and enable switches 13.

As illustrated in FIG. 1, the display unit 11 and the input operation unit 12 are disposed on the front side of the robot operation device 10. The display unit 11 is a display that displays information pertaining to a teaching task and robot control. The input operation unit 12 is an interface with which information pertaining to a teaching task and information pertaining to robot control are input. FIG. 2 is a schematic diagram of the robot operation device 10, the schematic diagram illustrating the enable switches 13, which are provided for the robot control device 20 according to the first embodiment. FIG. 2 depicts enable switches 13 disposed on the back side of the robot operation device 10. In the example depicted in FIG. 2, the enable switches 13 are disposed on the back side of the robot operation device 10. However, the position at which the enable switches 13 are disposed is not limited.

When activated by an operator, an enable switch 13 permits the robot 2 to take action. For example, the enable switch 13 has a three-position switch structure. The three-position switch structure has: a first position that is set when the operator is not in contact with the switch; a second position that is an intermediate position and is also an active position; and a third position that is set when the operation of pressing the switch hard by the operator is detected. When the enable switch 13 is set to the first position due to the operator releasing the switch when sensing danger, or when the enable switch 13 is set to the third position due to the operator pressing the switch hard, the robot control device 20 stops the action of the robot 2. In this way, the safety of the operator is ensured when performing a task in the vicinity of the robot 2 during, for example, a teaching task.

A teaching operation and the like that rely on the robot operation device 10 can be performed only when the enable switch 13 is activated. The robot operation device 10 including enable switches 13 is also an enable apparatus that determines, on the basis of the state of gripping by the operator, whether to permit operation of the robot 2.

The robot control device 20 is an information processing device that performs various types of processing in order to control the robot 2. The robot control device 20 receives information indicating operation details of the operator from the robot operation device 10 and controls the action of the robot 2 on the basis of the operation details.

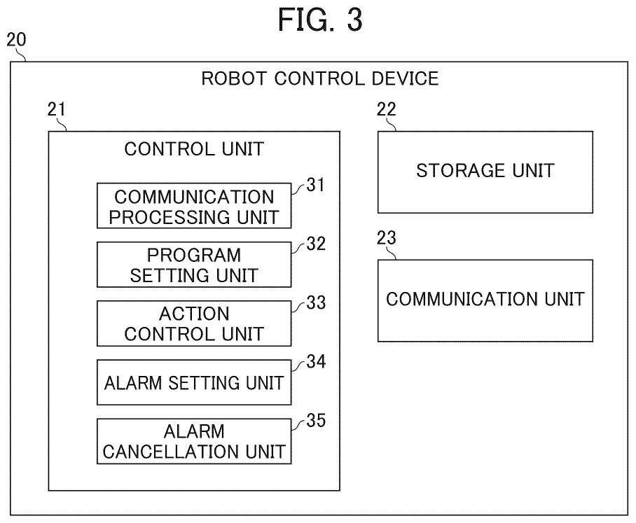

Descriptions are given of the functional configuration of the robot control device 20 with reference to FIG. 3. FIG. 3 is a block diagram illustrating a configuration example of the robot control device 20 according to the first embodiment. The robot control device 20 includes a control unit 21 that performs various types of processing, a storage unit 22 that stores various types of information pertaining to control for the robot 2, and a communication unit 23 electrically connected to external devices.

The control unit 21 is formed from a processor such as a central processing unit (CPU). The control unit 21 implements the functions of a communication processing unit 31, a program setting unit 32, an action control unit 33, an alarm setting unit 34, and an alarm cancellation unit 35 by executing various types of programs stored by the storage unit 22.

The storage unit 22 is formed from, for example, a read only memory (ROM), a random access memory (RAM), a nonvolatile memory, and/or a hard disk drive, and stores various types of data. For example, the ROM of the storage unit 22 stores system software for controlling the robot 2 and system software for performing image processing. Meanwhile, the nonvolatile memory of the storage unit 22 stores: a robot program for teaching task details of the robot 2 in accordance with an application; and setting data associated with the robot program. The RAM of the storage unit 22 is used for a storage region for temporary storage of data in various types of arithmetic processing performed by the control unit 21.

The communication unit 23 is a network interface connected to external devices such as the robot 2 and the robot operation device 10 over a network. External devices connected over the network include an information processing device such as a management computer for managing the entirety of the system.

The following describes the functions of functional units implemented by the control unit 21. The communication processing unit 31 controls, via the communication unit 23, the transmission/reception of information to/from an external device. The communication processing unit 31 also acquires, as an operation state indicating whether or not operation of the robot 2 is permitted, a signal indicating the state of gripping the enable switches 13 of the robot operation device 10.

The program setting unit 32 performs the process of creating a task program including action details and task position information for the robot 2 on the basis of teaching data set by the operator. For example, the teaching data is input through a teaching task in which the operator inputs, for example, a task position to the robot 2 by using the robot operation device 10.

The action control unit 33 performs the process of controlling the action of the robot 2 on the basis of operation details of the robot operation device 10 and the program created by the program setting unit 32.

The alarm setting unit 34 determines whether an abnormality of the robot 2 has occurred, and sets an alarm if an abnormality has occurred. On the basis of the abnormality determined as having occurred, the alarm setting unit 34 causes the action control unit 33 to stop the robot 2.

Determinations as to whether an abnormality has occurred are made on the basis of determination conditions that are set for individual types of abnormalities in advance. For example, determination conditions to be set include: the robot 2 having gone outside of a setting region set for the robot 2; a fault having occurred in communication with an external device performed over a network; and a signal indicating that operation of the robot 2 is not permitted having been received from the robot operation device 10.

The alarm setting unit 34 performs the process of displaying an alarm on a display together with details of an abnormality, and the process of outputting an alarm to, for example, a speaker together with details of an abnormality, the speaker producing a sound or a machine sound. For example, the display displays a history of a plurality of alarms in a list form. The display for displaying details of an alarm is, but is not particularly limited to, the display unit 11 of the robot operation device 10, a display unit (not shown) provided at the robot control device 20, the display unit of an external device (not shown) connected over a network, etc.

The alarm cancellation unit 35 performs cancellation processing for cancelling an alarm when a preset cancellation condition is satisfied. In the cancellation processing, an alarm is stopped, and the displaying of the alarm on the display is stopped. The cancellation processing also includes performing the process of permitting the robot 2 to take action after the alarm is cancelled.

The alarm cancellation conditions include: a preset abnormality of the robot 2 having been eliminated; and the operation state of the robot operation device 10 having been switched from a state in which operation of the robot 2 is not permitted to a state in which operation of the robot 2 is permitted.

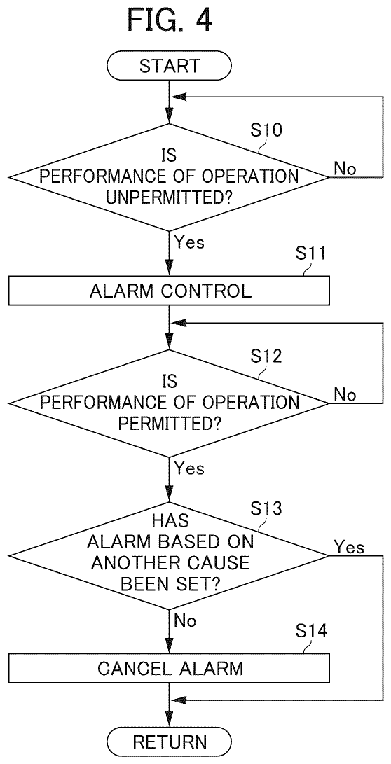

The following describes alarm processing based on the operation state of the robot operation device 10 with reference to FIG. 4. FIG. 4 is a flowchart illustrating an example of alarm processing based on an operation state achieved by the robot control device 20 according to the first embodiment.

First, on the basis of an operation state received by the communication processing unit 31 from the robot operation device 10, the alarm setting unit 34 determines whether or not operation of the robot 2 has been unpermitted (Step S10). When the grip position of an enable switch 13 of the robot operation device 10 indicates the first or third position, the alarm setting unit 34 determines that the operation state indicates that operation of the robot 2 is not permitted. When a signal from the robot operation device 10 indicates that the grip position of the enable switch 13 is the second position, i.e., the intermediate position, the alarm setting unit 34 determines that the operation state indicates that operation of the robot 2 is permitted.

When the operation state indicates that operation of the robot 2 is permitted, the alarm setting unit 34 continues to monitor the operation state (Step S10: No). When the operation state indicates that operation of the robot 2 is unpermitted, the alarm setting unit 34 shifts the flow to Step S11 (Step S10: Yes).

In Step S11, the alarm setting unit 34 performs alarm control for performing the process of setting an alarm and causing the action control unit 33 to stop the action of the robot 2 (Step S11). For example, the alarm setting unit 34 performs the process of setting an alarm, and outputs an abnormality by means of a device serving as an informing means, such as a display or a speaker, thereby informing the operator that an abnormality has occurred. Furthermore, the alarm setting unit 34 causes the action control unit 33 to stop the action of the robot 2.

After Step S11, on the basis of the operation state of the robot operation device 10 after the alarm setting, the alarm cancellation unit 35 determines whether or not operation of the robot 2 is permitted (Step S12). When the state of gripping the enable switch 13 corresponds to the second position, the alarm cancellation unit 35 determines that performance of operations have been permitted, and shifts the flow to Step S13 (Step S12: Yes). When the state of gripping the enable switch 13 corresponds to the first or third position, the alarm cancellation unit 35 determines that performance of operations have been unpermitted, and continues to monitor signals from the robot operation device 10 (Step S12: No).

In Step S13, the alarm cancellation unit 35 determines whether an alarm based on another cause that is different from the alarm based on the operation state has been set. For example, the alarm cancellation unit 35 determines whether another alarm has been set, such as an alarm based on the robot 2 having moved to the outside of the setting region or an alarm based on a communication fault.

When an alarm based on another cause that is different from the alarm based on the operation state has been set, the alarm cancellation unit 35 ends the flow without cancelling the alarm (Step S13: Yes). When an alarm based on another cause has not been set, the alarm cancellation unit 35 shifts the flow to Step S14 (Step S13: No). In Step S14, the process of cancelling the alarm that has been set is performed (Step S14), and the flow is returned to Step S10. In the alarm cancellation processing, the alarm based on the operation state is cancelled, and the robot 2 is allowed to take action. Note that the cancellation processing does not necessarily need to involve allowing the robot 2 to take action, but, depending on the situation, may involve only cancelling the alarm.

As described above, the robot control device 20 according to the first embodiment includes: the communication processing unit 31 that obtains, from the robot operation device 10 that serves as an enable apparatus, an operation state indicating whether or not operation of the robot 2 is permitted; the alarm setting unit 34 that stops the action of the robot 2 and sets an alarm in a case where the operation state indicating that operation of the robot 2 is not permitted has been obtained or another abnormality of the robot 2 that is not based on the operation state has been detected; and the alarm cancellation unit 35 that, in a case where an operation state indicating that operation of the robot 2 is permitted has been obtained with an alarm having been set, performs, when the only alarm that has been set is an alarm based on the operation state, cancellation processing for cancelling the alarm that has been set. Meanwhile, the robot system 1 includes the robot operation device 10 and the robot control device 20.

According to the robot control device 20 and the robot system 1 which have the configurations described above, an alarm is automatically cancelled when the operation state of the robot operation device 10 is the only cause of an abnormality, so the occurrence of an abnormality of the robot 2 that is based on another factor does not fail to be recognized amid the alarm based on the operation state, and the efficiency of task of identifying an alarm indicating an abnormality of the robot 2 can be enhanced.

The following describes the configurations of robot systems differently configured from the first embodiment. In the following descriptions, identical or similar components are given identical reference marks to those already described hereinabove, and descriptions thereof may be omitted herein.

### Second Embodiment

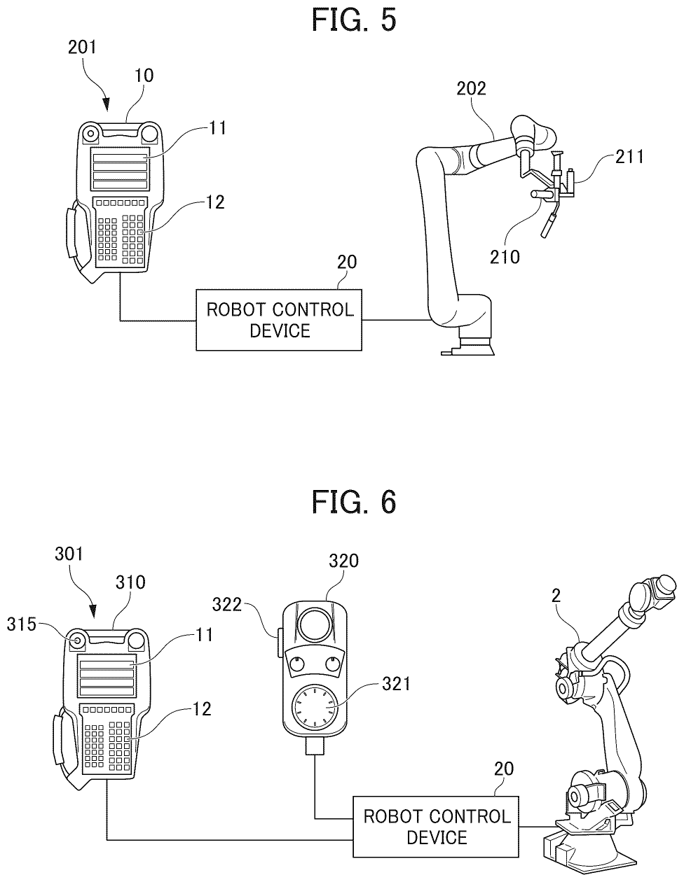

FIG. 5 is a schematic diagram illustrating the configuration of a robot system 201 according to a second embodiment of the present disclosure. The robot system 201 according to the second embodiment includes a robot 202, a hand guide unit 210, a robot operation device 10, and a robot control device 20.

The robot 202 is a collaborative robot including the hand guide unit 210. The robot 202 has a safety stop function for stopping the action of the robot 202 if the same contacts an obstacle such as an operator.

The hand guide unit 210 is a handling device for an operator and attached to the robot 202. The operator grips and handles the hand guide unit 210 so as to cause the robot 202 to take action. The robot 202 includes a detection unit for detecting the direction of an external force applied to the hand guide unit 210. The detection unit is formed from, for example, a force sensor and/or a torque sensor. The action control unit 33 causes the robot 202 to take jogging action on the basis of the direction of an external force detected by the detection unit.

The hand guide unit 210 is also an enable apparatus including an enable switch 211. The enable switch 211 has a similar three-position structure to the enable switches 13 and transmits, to the robot control device 20, an operation state indicating whether or not operation of the robot 202 is permitted. Thus, the robot system 201 according to the second embodiment includes two enable apparatuses, namely, the robot operation device 10, which is a teaching operation panel, and the hand guide unit 210, which is an operation device.

The hand guide unit 210 according to the second embodiment is gripped by a single operator with both hands. Thus, the single operator cannot operate the hand guide unit 210 concurrently with gripping the enable switch of the robot operation device 10. Accordingly, when the operation state of the robot operation device 10 or the hand guide unit 210 indicates that operation of the robot 202 is permitted, the robot control device 20 determines that safety has been ensured, and performs control so as to cause the robot 202 take action.

When the operation state of the robot control device 20 indicates that operation of the robot 202 is not permitted and the operation state of the hand guide unit 210 indicates that operation of the robot 202 is not permitted, the alarm setting unit 34 in the second embodiment sets an alarm based on the operation states. Then, the alarm setting unit 34 causes the action control unit 33 to stop the action of the robot 202.

When at least one of the operation state of the robot control device 20 or the operation state of the hand guide unit 210 indicates that operation of the robot 202 is permitted, the alarm cancellation unit 35 determines that operation of the robot 202 can be permitted. Then, only when an alarm that has been set is based on an operation state, the alarm is cancelled, and the robot 202 is permitted to take action. In the second embodiment, the alarm cancellation unit 35 also cancels an alarm and allows the robot 202 to take action.

In the second embodiment, as described above, the communication processing unit 31 obtains operation states from the plurality of enable apparatuses of the robot control device 20 and the hand guide unit 210; and when the operation state of at least one of the robot control device 20 or the hand guide unit 210 indicates, with an alarm having been set, that operation of the robot 202 is permitted, the alarm cancellation unit 35 performs the alarm cancellation processing.

With the robot 202 having a safety stop function and thus securing safety, the abovementioned features enable the effective suppression of occurrence of situations in which an alarm based on an operation state of relatively low importance continues to be set. Accordingly, another abnormality that is different from the abnormality based on an operation state can be grasped more easily.

### Third Embodiment

FIG. 6 is a schematic diagram illustrating the configuration of a robot system 301 according to a third embodiment of the present disclosure. The robot system 301 according to the third embodiment includes a robot 2, a robot operation device 310, a manual pulse generator 320, and a robot control device 20.

The robot operation device 310 includes a display unit 11, an input operation unit 12, an enable switch 13, and an operation-device selection button 315. The operation-device selection button 315 is a switch for selecting one of the robot operation device 310 or the manual pulse generator 320 as an operation means for the robot 2. In the third embodiment, turning on the operation-device selection button 315 causes the robot operation device 310 to be set as the operation means for the robot 2, and turning off the operation-device selection button 315 causes the manual pulse generator 320 to be set as the operation means for the robot 2.

The manual pulse generator 320 includes a dial part 321 for causing the robot 2 to take jogging action. As described above, the manual pulse generator 320 is set as the operation means for the robot 2 while the operation-device selection button 315 of the robot operation device 310 is off.

The manual pulse generator 320 is also an enable apparatus including an enable switch 322. The enable switch 322 has a similar three-position structure to the enable switch 13 and can transmit, to the robot control device 20, an operation state indicating whether or not operation of the robot 2 is permitted.

When the operation state of one from among the robot operation device 310 and the manual pulse generator 320 that has been set as the operation means indicates that operation of the robot 2 is not permitted, the alarm setting unit 34 sets an alarm and causes the action control unit 33 to stop the action of the robot 2. In the third embodiment, even when the operation state of one from among the robot operation device 310 and the manual pulse generator 320 that has not been set as the operation means indicates that operation of the robot 2 is not permitted, an alarm is not set and the action of the robot 2 is not stopped on the basis of such a fact.

When the operation state of one from among the robot operation device 310 and the manual pulse generator 320 that has been set as the operation means indicates, with an alarm having been set, that operation of the robot 2 is permitted, the alarm cancellation unit 35 performs alarm cancellation processing. In the cancellation processing, when the only alarm that has been set is an alarm based on an operation state, the alarm is cancelled, and the robot 2 is allowed to take action.

For example, while the robot operation device 310 is selected as the operation means, the alarm setting unit 34 sets an alarm when the enable switch 13 is released, but does not set an alarm when the enable switch 322 of the manual pulse generator 320 is released. While the robot operation device 310 is selected as the operation means with an alarm having been set, switching the operation state of the robot operation device 310 to a state in which operation of the robot 2 is permitted, causes the alarm cancellation unit 35 to perform the cancellation processing such that, when the only alarm that has been set is an alarm based on an operation state, the alarm is cancelled, thereby allowing operation of the robot 2. Meanwhile, the alarm is not cancelled even when the enable switch 322 of the manual pulse generator 320, which has not been set as the operation means, is gripped at the second position.

In contrast, while the manual pulse generator 320 is selected as the operation means, the alarm setting unit 34 sets an alarm when the enable switch 322 is released, but does not set an alarm when the enable switch 13 of the robot operation device 310 is released. While the manual pulse generator 320 is selected as the operation means with an alarm having been set, switching the operation state of the manual pulse generator 320 to a state in which operation of the robot 2 is permitted, causes the cancellation processing to be performed such that, when the only alarm that has been set is an alarm based on an operation state, the alarm is cancelled, thereby allowing operation of the robot 2. Meanwhile, the alarm is not cancelled even when the enable switch 13 of the robot operation device 310, which has not been set as the operation means, is gripped at the second position.

In the third embodiment, as described above, the communication processing unit 31 obtains the operation state of one selected from among the robot operation device 310 and the manual pulse generator 320; and when the operation state of one selected from among the robot operation device 310 and the manual pulse generator 320 indicates, with an alarm having been set, that operation of the robot 2 is permitted, the alarm cancellation unit 35 performs the alarm cancellation processing.

Owing to this feature, in the situation in which an operation means is selected from among the robot operation device 310 and the manual pulse generator 320, an alarm is cancelled on the basis of the operation state of the active operation means, so that, while preventing unintentional alarm cancellation that could be caused by operating an unselected operation means, the alarm based on the operation state can be prevented from continuing to be set.

### Fourth Embodiment

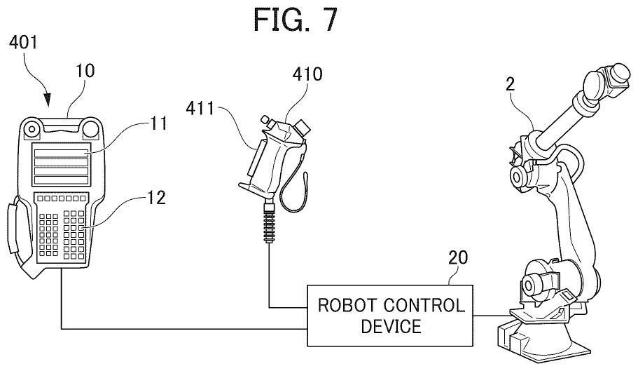

FIG. 7 is a schematic diagram illustrating the configuration of a robot system 401 according to a fourth embodiment of the present disclosure. The robot system 401 according to the third embodiment includes a robot 2, a robot operation device 10, an enable device 410, and a robot control device 20.

The enable device 410 is an enable apparatus that includes an enable switch 411, one or a plurality of said enable apparatuses being installed. The enable switch 411 has a similar three-position structure to the enable switch 13 and can transmit, to the robot control device 20, an operation state indicating whether or not operation of the robot 2 is permitted.

The number of enable devices 410 is set on the basis of the number of persons who work inside the safety fence. Operators who work inside the safety fence each carry an enable device 410. The action control unit 33 causes the robot 2 to take action only when the operation states of the robot operation device 10 and all of the enable apparatuses of the enable devices 410 have permitted operation of the robot 2.

The alarm setting unit 34 sets an alarm and causes the action control unit 33 to stop the action of the robot 2 when the operation state of at least one from among the robot operation device 10 and the enable devices 410 does not permit operation of the robot 2.

In a case where the operation states of the robot operation device 10 and all of the enable devices 410 indicate, with an alarm having been set, that operation of the robot 2 is permitted, when the only alarm that has been set is an alarm based on the operation state of the robot operation device 10 or the operation state of an enable device 410, the alarm cancellation unit 35 automatically cancels the alarm so that the robot 2 can be operated.

In the fourth embodiment, as described above, the communication processing unit 31 obtains the operation states of the robot operation device 10 and the enable devices 410; and in a case where the operation states of the robot operation device 10 and all of the enable devices 410 indicate, with an alarm having been set, that operation of the robot 2 is permitted, the alarm cancellation unit 35 performs the alarm cancellation processing.

Owing to this feature, when the safety of all the operators who carry the robot operation device 10 or an enable device 410 need to be reliably ensured, the alarm is not cancelled unless the operation states of all of the enable apparatuses indicate that operation of the robot 2 is permitted. Accordingly, with safety ensured, a situation can be avoided in which an alarm based on an operation state of relatively low importance continues to be set and an alarm that was generated in the past is drown out.

Although embodiments of the present disclosure have been described, the robot control device according to the present disclosure is not limited to the embodiments described above. The effects described with reference to each embodiment are merely a list of the most preferable effects caused by the robot control device, and the effects provided by the robot control device of the present disclosure are not limited to those described with reference to the embodiments. For examples, features of embodiments may be combined. The enable apparatuses are not limited to mechanical means such as switches, and may be configured to transmit an operation state indicating that operation of the robot is permitted on the basis of a result of detection by a detection unit formed from, for example, a contact sensor or a biosensor.

### Explanation of Reference Numerals

1: Robot system
10: Robot operation device (enable apparatus)
20: Robot control device
31: Communication processing unit
34: Alarm setting unit
35: Alarm cancellation unit
210: Hand guide unit (enable apparatus)
320: Manual pulse generator (enable apparatus)
410: Enable device (enable apparatus)

1. A robot control device comprising:
a communication processing unit that obtains, from an enable apparatus, an operation state indicating whether or not operation of a robot is permitted;
an alarm setting unit that stops an action of the robot and sets an alarm in a case where the operation state indicating that operation of the robot is not permitted has been obtained or another abnormality of the robot that is not based on the operation state has been detected; and
an alarm cancellation unit that, in a case where the operation state indicating that operation of the robot is permitted has been obtained with the alarm having been set, performs, when an only alarm that has been set is the alarm based on the operation state, cancellation processing for cancelling the alarm that has been set.

2. The robot control device according to claim 1, wherein
the communication processing unit
obtains the operation states from a plurality of the enable apparatuses, and
the alarm cancellation unit
performs the cancellation processing when the operation state of at least one of the plurality of the enable apparatuses indicates, with the alarm having been set, that operation of the robot is permitted.

3. The robot control device according to claim 1, wherein
the communication processing unit
obtains the operation state of the enable apparatus selected from a plurality of the enable apparatuses, and
the alarm cancellation unit
performs the cancellation processing when the operation state of the enable apparatus selected from the plurality of the enable apparatuses indicates, with the alarm having been set, that operation of the robot is permitted.

4. The robot control device according to claim 1, wherein
the communication processing unit
obtains the operation states from a plurality of the enable apparatuses, and
the alarm cancellation unit
performs the cancellation processing when the operation states of all of the plurality of the enable apparatuses indicate, with the alarm having been set, that operation of the robot is permitted.

5. A robot system comprising:
an enable apparatus that transmits an operation state indicating whether or not operation of a robot is permitted; and
a robot control device to which the robot and the enable apparatus are connected, wherein
the robot control device includes
a communication processing unit that obtains the operation state from the enable apparatus,
an alarm setting unit that stops an action of the robot and sets an alarm in a case where the operation state indicating that operation of the robot is not permitted has been obtained or another abnormality of the robot that is not based on the operation state has been detected, and
an alarm cancellation unit that, in a case where the operation state indicating that operation of the robot is permitted has been obtained with the alarm having been set, performs, when the only alarm that has been set is the alarm based on the operation state, cancellation processing for cancelling the alarm that has been set.
